(19) United States
(12) Patent Application Publication
(10) Pub. No.: US 2024/0390740 A1
(43) Pub. Date: Nov. 28, 2024

(54) A GOLF BALL PICKUP ATTACHMENT FOR A GOLF CLUB

(71) Applicants: Chris DIMMOCK, Sydney (AU); Garry THORLEY, Sydney (AU)

(72) Inventors: Chris DIMMOCK, Sydney (AU); Garry THORLEY, Sydney (AU)

(21) Appl. No.: 18/686,323

(22) PCT Filed: Aug. 24, 2022
(86) PCT No.: PCT/AU2022/050971

§ 371 Date: Feb. 23, 2024

(30) Foreign Application Priority Data
Aug. 25, 2021 (AU) 2021902724

(51) Int. Cl. A63B 47/02; A63B 60/00

(52) U.S. Cl. CPC A63B 47/02; A63B 60/00

(57) ABSTRACT

A golf ball pickup attachment for a golf club has a fork having a base and a pair of tines. In use, the base of the golf ball pickup attachment is attachable to a handle end of a shaft the golf club in use so that the tines can hold a golf ball therebetween for convenient pickup of golf ball from green surfaces, from in golf holes and the like.

### FIELD OF THE INVENTION

This invention relates generally to a golf ball pickup attachment for a golf club.

### SUMMARY OF THE DISCLOSURE

There is provided herein a golf ball pickup attachment for a golf club, such as a putter. The attachment comprises a fork having a base and a pair of tines. In use, the base is attachable to a handle end of a shaft the golf club in use and the tines can hold a golf ball therebetween.

The unique pressed shape of the fork in embodiments allows for a positive pin point grip to hold the golf ball in an optimum position whilst also allowing for the easy removal of the ball from the fork.

The narrowing tines of the fork in embodiments allows the ball to be picked up with the club held at an angle. Furthermore, the slimline aspect of the base of the fork in embodiments allows easy access and removal of the attachment from golf bags and also allows the removal of the ball from the golf cup whilst the flag is in position.

The metallic plate of the fork in embodiments allows for the fork to be readjusted to suit different size balls and corrected from any misuse and can be manufactured in different materials for appearance and longevity, such as polished stainless, anodised aluminium or painted or powder coated steel. These materials are not subject to heat degradation like plastic components would.

The fork may be attached to the golf club using an adapter.

One form of adapter allows for a rigid fit-type connection by engaging inside the golf club shaft. This adaptor may have a common thread size which allows for both a grub screw to expand the adapter and a fastening screw to engage the fork to the adapter.

The grub screw may have tapered end as does the distal end of the bore of the adapter so that, when the grub screw is tightened, the grub screw causes the male end of the adapter within the shaft to expand. Longitudinal slits separating the male end into portions may allow the male end to expand and to fit a vast array of shafts. With this adapter, the fork can be rotated to any position as to suit any grip on the club. The adapter can also be used as a mounting method to fit training and alignment tools to the end of the club.

The quick fit-type adapter uses a spacer which can be secured to the shaft by inserting, drilling or screwing a fastener therethrough into the club and wherein a secondary fastener may fasten the fork to the secured spacer thereby allowing for quick fit attachment and for a smaller hole in the handle of the club as compared to the above rigid fit connection. The spacer may be countersunk for flush fit of the fastener screw.

The unique pressed shape of the present attachment in embodiments allows for pin point pressure and holding power that can be adjusted to have 2-5 points of contact with a ball and allows for offset pick up wherein the ball does not have to be centred in the attachment to be picked up. Furthermore, the pressed shape allows removal of the ball from cup whilst flag is still in and is design also allows for non-snagging entry and removal from golf bags.

The adapter gives a strong and rigid mounting platform for both the ball pick up and other attachments like training and alignment components (multi-use) and the construction materials confer longevity whist allowing for readjustment of the attachment and the combination of the construction material and design should last a lifetime.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a disassembled view of a secure fit-type golf ball pickup attachment for a golf club;

FIG. 2 shows an adapter of the attachment of FIG. 1;

FIG. 3 shows the attachment of FIG. 1 security golf ball;

FIG. 4 shows a disassembled view of a quick fit-type golf ball pickup attachment for a golf club in accordance with a further embodiment;

FIG. 5 shows a spacer adapter of the attachment of FIG. 4; and

FIG. 6 shows the attachment of Figure for engaging a golf ball.

### DESCRIPTION OF EMBODIMENTS

A golf ball pickup attachment 100 for a golf club 101 comprises a fork 102 having a base 103 and a pair of tines 104. In use, the base 103 is attachable to a handle end of a shaft 105 of the golf club 101 so that the tines 104 can hold a golf ball 106 therebetween.

The tines 104 define a gap therebetween slightly less than the diameter of the golf ball 106 so that, in use, the tines 104 expand slightly when the golf ball 106 is pressed therebetween so that the tines 104 forcefully bear against opposite sides of the golf ball 106. Whereas the diameter of a conventional golf ball may be 42.67 mm, the gap between the tines 104 may be approximately 40 mm or less.

In the embodiment shown, the fork 102 is a shaped plate 107, preferably metallic.

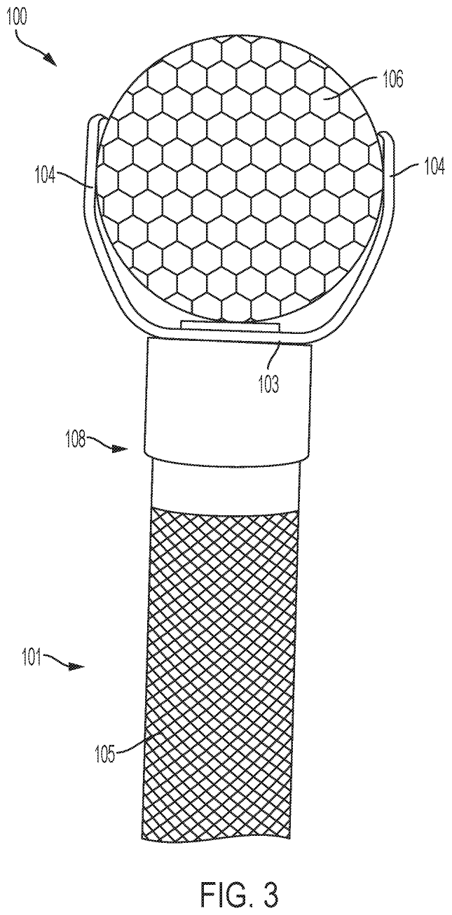

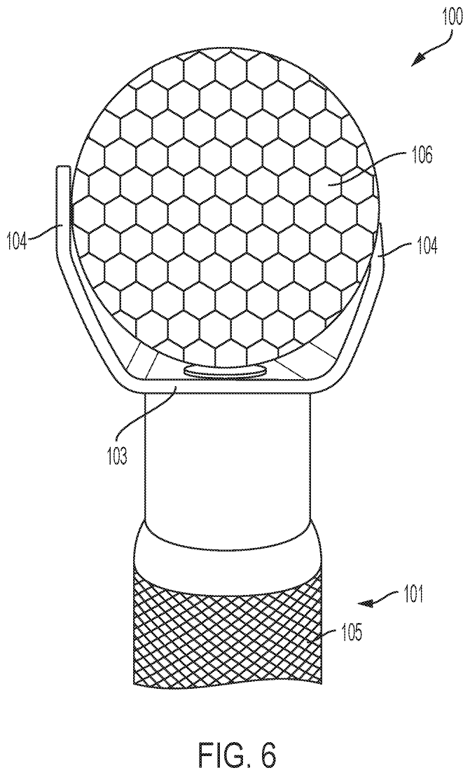

The plate 107 may be shaped so that the golf ball 106 contacts the attachment 100 at more than one point as shown in FIG. 3 or 6 including inner faces of the tines 104 and an upper surface of the base 103. For example, the plate 107 may contact the ball 106 at the tine 104 tips, the angled sides of the tines 104 and the fastening screw 116 or the upper surface of the base 103. In embodiments, the plate 107 can be adjusted to have between 2 and 5 points of contact with the ball 106.

The tines may extend more than 21 mm from the upper surface of the base 103 of the plate 107 to reach beyond sides of a conventionally sized golf ball.

The base 103 may be flat and attachable across the end of the shaft 105. Furthermore, distal ends of the tines 104 may be orthogonal with respect to the flat base 103. Furthermore, the distal ends of the tines 104 may themselves also be planar so as to allow for golf ball position tolerance therebetween. The tips of the tines 104 may be slightly splayed apart in embodiments.

The fork 104 is preferably rotatable with respect to the shaft 105 when attached to the shaft so that the orientation of the fork 104 may be adjusted depending on the orientation of the head of the golf club 101.

The plate 107 may narrow in width from the base 103 towards each tine 104. Probably, each tine 104 narrows in width continuously from the base 103 to the distal ends thereof. This narrowing towards the tines 104 allows the golf ball 106 to be picked up with the club 101 at an angle with respect to the ground.

The base 103 preferably has a width of less than 44.5 mm so as to be able to reach into green hole cups to retrieve golf balls 106 even with a flag installed therein.

The attachment 100 may comprise an adapter interfacing the base 103 and the end of the shaft 105.

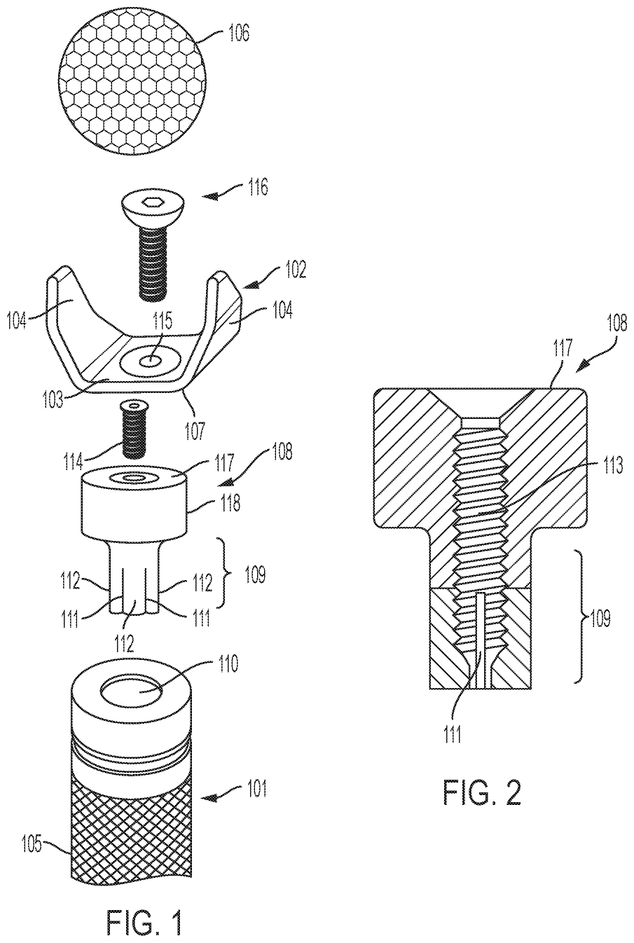

The embodiments of FIGS. 1-3 show a rigid fit-type adapter 108 having a male end 109 which inserts into the end of the shaft 105. As shown in FIG. 1, a conforming size aperture 110 may be made in the rubber grip of the handle of the club 101 through which the male end 109 inserts into the interior of the shaft 105.

The male end 109 may expand when inside the shaft. Specifically, the male end 109 may comprise a plurality of longitudinally orientated slits 111 along an insertion axis of the adapter 108 which separate the male end 109 into a plurality of portions 112 which can expand outwardly when inside the shaft 105.

With reference to FIG. 2, the adapter 108 may comprise a bore 113 through to the male and 109 and wherein an insert is inserted therein to expand the male end 109.

The bore 113 may be threaded and, with reference to FIG. 1, the insert may comprise a grub screw 114 which, when screwed into the threaded bore 113 to the male and 109, causes the portions 112 to expand outwardly to frictionally engage the interior surface of the shaft. The distal end of the grub screw 114 may be tapered and the bore 113 may have a corresponding constriction as shown in FIG. 2 so that the grub screw 114 causes the portions 112 to expand when reaching the distal end of the bore 113.

The base 103 may comprise an aperture 115 therethrough and wherein a fastener 116 goes through the base 103 and into the adapter 108 to hold the fork 102 to the adapter 108.

The fastener 116 may be a screw fastener which screws into the threaded bore 113. The bore 113 may have a common thread pitch and diameter and wherein the screw fastener 116 and grub screw 114 have a common thread pitch and diameter so that the screw fastener 116 can follow the grub screw 114 into the bore 113.

The adapter 108 may comprise a planar interface 117 which bears flat against an underside of the base 103.

The adapter 108 may comprise a head 118 which is wider than the male end 109 and an interior diameter of the shaft 105.

The aperture 115 may be countersunk on an upper surface of the base 103 and the fastener 116 may be a conforming countersunk screw.

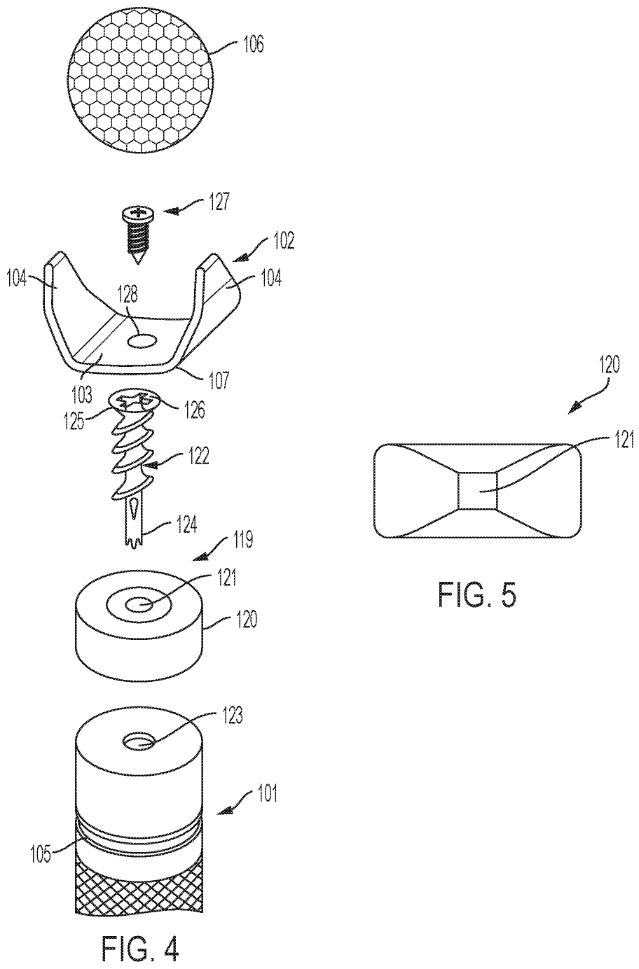

FIGS. 4-6 show a quick fit-type adapter 119 comprising a spacer 120 having a bore 121 therethrough and wherein a fastening screw 122 fastens the spacer 120 to an end of the shaft 105 and wherein the base 103 fastens to the spacer 120.

The screw fastener 122 allows a smaller diameter aperture 123 to be formed in the golf club 101 as compared to the aperture 110 shown in FIG. 1. Furthermore, the fastener 122 may be course threaded to adequately engage the handle rubber or like material of the club 101. The fastener 122 may comprise a drill bit end 124 to allow the fastener 122 to be drilled into the grip 101 through the spacer 120.

A head 125 of the fastening screw 122 may comprise a threaded blind bore 126 therein for a secondary fastening screw 127 which goes through an aperture 128 of the base 103 and screwably engages the threaded blind bore 126.

As shown in FIG. 5, the spacer 120 may be countersunk for a conformingly countersunk shaped head 125 of the fastener 122. As is further shown in FIG. 5, the spacer 120 may be countersunk on an undersurface thereof to ensure a positive fit when mating it with a grip that has been manufactured with an end radius.

In embodiments, the spacer 120 may have a counterbore formed therein (as opposed to a countersink) and wherein the base 103 of the fork 102 is pressed to form a countersink which extends under the base 103. As such, when the base 103 of the fork 102 is placed on top of the spacer 120, a top surface of the pressed countersink of the base 103 is engaged by the head of the fastening screw 127 and the pressed countersink of the base 103 extends into the counterbore of the spacer 120.

Similarly, in embodiments, the base 103 of the fork 102 of the embodiment of FIG. 1 may be pressed to form a countersink extending under the base 103. Furthermore, the interface 117 of the adapter 108 may have a conforming countersunk depression to accommodate the countersunk undersurface of the base 103 of the fork 102 therein.

In embodiments, the spacer 120 may comprise a tapered undercut to enhance mating with the radial end surface of the end of the rubber grip of the shaft 105. In embodiments, the male end 109 of the adapter 108 may comprise a tapered undercut to enhance mating with the radial undersurface of the shaft 105.

Using the attachment 100 to pick up a golf ball 106 may comprise attaching the attachment 100 to the handle end of the club 101 in use and holding the club 101 upside down to pick up the golf ball 106 from the ground using the fork 102.

The adapter of FIGS. 1-3 may be used for a more permanent rigid fit-type installation wherein a relatively larger aperture 110 can be formed in the golf club 101 or alternatively the adapter 119 of FIGS. 4-6 may be used for a more quick fit-type installation.

As alluded to above, the sizing of the base 103 may allow the fork 102 to fit into a green cup hole with a flag installed therein to retrieve the golf ball 106.

Furthermore, the way in which the plate 107 narrows towards the tines 104 may allow the golf ball 106 to be picked up with the club 101 held at an angle to the ground.

Furthermore, the fork 102 may be rotated with respect to the orientation of the golf club head so that the fork 102 is correctly orientated when picking up the golf ball.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A golf ball pickup attachment for a golf club, the attachment comprising a fork having a base and a pair of tines, wherein, in use, the base is attachable to a handle end of a shaft the golf club in use and the tines can hold a golf ball therebetween.

2. An attachment as claimed in claim 1, wherein the tines define a gap therebetween slightly less than the diameter of the golf ball so that, in use, the tines expand slightly when the gold ball is pressed therebetween in use so that the tine forcefully bear against opposite sides of the golf ball.

3. An attachment as claimed in claim 1, wherein the fork is a shaped plate.

4. An attachment as claimed in claim 3, wherein the plate is metallic.

5. An attachment as claimed in claim 3, wherein the plate is shaped to that, in use, the golf ball contacts the attachment at more than three points being inner faces of the tines and an upper surface of the plate.

6. An attachment as claimed in claim 3, wherein the tines extend more than 21 mm from the upper surface of the plate.

7. An attachment as claimed in claim 3, wherein the fork defines a flat base attachable across the end of the shaft.

8. An attachment as claimed in claim 7, wherein distal ends of the tines are substantially orthogonal with respect to the flat base.

9. An attachment as claimed in claim 8, wherein the distal ends of the tines are planar.

10. An attachment as claimed in claim 7, wherein the base has a width of less than 44.5 mm.

11. An attachment as claimed in claim 7, wherein the plate narrows in width from the base to each tine.

12. An attachment as claimed in claim 11, wherein each tine narrows in width continuously from the base to distal ends of each tine.

13. An attachment as claimed in claim 1, wherein the fork is rotatable with respect to the shaft when attached to the shaft.

14. An attachment as claimed in claim 7, further comprising an adapter for interfacing the base and the end of the shaft.

15. An attachment as claimed in claim 14, wherein the adapter comprises a male end which inserts into the end of the shaft.

16. An attachment as claimed in claim 15, wherein the male end expands when inside the shaft.

17. An attachment as claimed in claim 16, wherein the male end comprises a plurality of slits along an insertion axis of the adapter which separate the male end into a plurality of portions which can expand outwardly when inside the shaft.

18. An attachment as claimed in claim 16, wherein the adapter comprises a bore through to the male end and wherein an insert inserted therein expands the male end.

19. An attachment as claimed in claim 18, wherein the bore is threaded and wherein the insert is a grub screw.

20. An attachment as claimed in claim 18, wherein the base comprises an aperture therethrough and wherein a fastener goes through the base and into the adapter to hold the fork to the adapter.

21. An attachment as claimed in claim 20, wherein the adapter comprises a planar interface which bears flat against the underside of the base.

22. An attachment as claimed in claim 21, wherein the adapter comprises a head wider than the male end and an interior diameter of the shaft.

23. An attachment as claimed in claim 20, wherein the aperture is countersunk on an upper surface thereof and wherein the fastener is a conforming countersunk screw.

24. An attachment as claimed in claim 15, wherein the adapter comprises a threaded bore through to the male end and wherein a grub screw inserted therein expands the male end and a fastening screw goes through the base plate to engage in the bore.

25. An attachment as claimed in claim 24, wherein the bore has a common thread and the grub screw and the fastening screw have a common thread pitch.

26. An attachment as claimed in claim 14, wherein the adapter comprises a spacer having a bore therethrough and wherein a fastening screw fastens the spacer to the end of the shaft and wherein the base fastens to the spacer.

27. An attachment as claimed in claim 26, wherein the fastening screw is coarse threaded.

28. An attachment as claimed in claim 26, wherein the fastener comprises a drill bit end to allow the fastener to be drilled into the grip through the spacer.

29. An attachment as claimed in claim 26, wherein a head of the fastening screw comprises a threaded blind bore therein for a secondary fastening screw which goes through the base and screwably engages in the threaded blind bore.

30. An attachment as claimed in claim 26, wherein the spacer is countersunk for the head of the fastening screw.

31. An attachment as claimed in claim 30, wherein the spacer is countersunk on opposite faces thereof.

32. A method of picking up a golf ball as claimed in claim 1, the method comprising attaching the attachment to the handle end of the club and holding the club upside down to pick up a ball from the ground with the fork.

33. A method of picking up a golf ball as claimed in claim 32, further comprising the attachment as claimed in claim 10, the method further comprising inserting the fork into a green hole cup wherein the fork fits between a flag retained by the cup and an inner surface of the cup and retrieving the ball from the cup using the fork.

34. A method of picking up a golf ball as claimed in claim 32, further comprising the attachment as claimed in claim 13, the method comprising rotating the form depending on the orientation of a head of the gold club.

35. A method of picking up a golf ball as claimed in claim 32, further comprising the attachment as claimed in claim 11, further comprising holding the club at an angle with respect to the ground to pick up the golf ball.
